(19) United States
(12) Patent Application Publication
(10) Pub. No.: US 2025/0054682 A1
(43) Pub. Date: Feb. 13, 2025

(54) COIL COMPONENT

(71) Applicant: Murata Manufacturing Co., Ltd., Kyoto-fu (JP)

(72) Inventors: Hayato TAKAHASHI, Nagaokakyo-shi (JP); Yuki KANBE, Nagaokakyo-shi (JP); Shingo NAKAMOTO, Nagaokakyo-shi (JP); Seiji KARIMORI, Nagaokakyo-shi (JP); Masayuki ISHIDA, Nagaokakyo-shi (JP)

(73) Assignee: Murata Manufacturing Co., Ltd., Kyoto-fu (JP)

(21) Appl. No.: 18/793,257

(22) Filed: Aug. 2, 2024

(30) Foreign Application Priority Data
Aug. 10, 2023 (JP) 2023-131422
Dec. 19, 2023 (JP) 2023-213975

(51) Int. Cl. H01F 27/28; H01F 17/04; H01F 27/29

(52) U.S. Cl. CPC H01F 27/2823; H01F 17/045; H01F 27/29

(57) ABSTRACT

A coil component includes a drum core including a core portion, first and second flange portions; first, second, third and fourth outer electrodes; and first and second wires. When the first wire is traced from a first wire end to a second wire end, a turn including a last point that makes contact with an outer surface of the core portion is referred to as an N-th turn. When the second wire is traced from a first wire end to a second wire end, a turn including a last point that makes contact with the outer surface of the core portion is referred to as an M-th turn. The M-th turn of the second wire and the N-th turn of the first wire do not include an intersection portion at which the M-th turn of the second wire and the N-th turn of the first wire intersect.

### CROSS-REFERENCE TO RELATED APPLICATIONS

This application claims benefit of priority to Japanese Patent Application No. 2023-131422, filed Aug. 10, 2023, and to Japanese Patent Application No. 2023-213975, filed Dec. 19, 2023, the entire content of each is incorporated herein by reference.

### BACKGROUND

### Technical Field

The present disclosure relates to a coil component.

### Background Art

A coil component described in Japanese Unexamined Patent Application Publication No. 2023-30170 includes a core, four outer electrodes, a first wire, and a second wire. The core includes a core portion, a first flange portion, and a second flange portion. The core portion has a rectangular prism shape. The first flange portion is coupled to a first end of the core portion. The second flange portion is coupled to a second end of the core portion. Two of the four outer electrodes are positioned on the surface of the first flange portion. The other two outer electrodes are positioned on the surface of the second flange portion.

The first wire is wound around the core portion. A first end of the first wire is coupled to one of the outer electrodes on the first flange portion. A second end of the first wire is coupled to one of the outer electrodes on the second flange portion. The second wire is wound around the core portion. A first end of the second wire is coupled to the other outer electrode on the first flange portion. A second end of the second wire is coupled to the other outer electrode on the second flange portion. The second wire is wound in the same direction as the first wire.

### SUMMARY

In some coil components like described in Japanese Unexamined Patent Application Publication No. 2023-30170, wires intersect each other in the vicinity of the second end of the core portion. When wires intersect each other in the vicinity of their second ends, heat from the outer electrodes is transmitted to the intersection of the wires and tends to concentrate at the intersection. Wires intersecting in the vicinity of their second ends are therefore subject to melting of insulation coatings and other damages at the intersection of the wires.

Accordingly, the present disclosure provides a coil component including a drum core including: a columnar core portion; a first flange portion coupled to a first end of the core portion in a direction along a central axis; and a second flange portion coupled to a second end of the core portion on a side opposite to the first end; a first outer electrode and a second outer electrode that are positioned on a surface of the first flange portion; a third outer electrode and a fourth outer electrode that are positioned on a surface of the second flange portion; a first wire that is wound around the core portion and has a first wire end coupled to the first outer electrode and a second wire end coupled to the third outer electrode; and a second wire that is wound around the core portion in the same direction as the first wire and has a first wire end coupled to the second outer electrode and a second wire end coupled to the fourth outer electrode. An M-th turn of the second wire and an N-th turn of the first wire do not have an intersection portion at which the M-th turn of the second wire and the N-th turn of the first wire intersect, and an (M−1)-th turn of the second wire and an (N−1)-th turn of the first wire have a first intersection portion at which the (M−1)-th turn of the second wire and the (N−1)-th turn of the first wire intersect where N and M are integers greater than or equal to 2. Also, when the first wire is traced from the first wire end to the second wire end, a first point that makes contact with an outer surface of the core portion is defined as a point of 1.0 turn of the first wire. The number of turns increases from the first wire end toward the second wire end of the first wire by one each time the first wire turns once around the central axis; and the N-th turn refers to a turn that includes a last point that makes contact with the outer surface of the core portion when the first wire is traced from the first wire end to the second wire end. Also, when the second wire is traced from the first wire end to the second wire end, a first point whose angular position about the central axis coincides with an angular position of the point of 1.0 turn of the first wire is defined as a point of 1.0 turn of the second wire. The number of turns increases from the first wire end toward the second wire end of the second wire by one each time the second wire turns once around the central axis; and the M-th turn refers to a turn including a last point that makes contact with the outer surface of the core portion when the second wire is traced from the first wire end to the second wire end.

According to the aforementioned configuration, it is possible to prevent insulation coatings from melting in the first intersection portion.

### BRIEF DESCRIPTION OF THE DRAWINGS

FIG. 1 is a perspective view of a coil component;

FIG. 2 is a plan view of the coil component;

FIG. 3 is a diagram explaining a winding manner of wires when the coil component is viewed in a third negative direction;

FIG. 4 is a diagram explaining the winding manner of wires when the coil component is viewed in a second positive direction;

FIG. 5 is a diagram explaining a winding manner of wires when a coil component of a modification is viewed in the second positive direction;

FIG. 6 is a plan view of a coil component;

FIG. 7 is a diagram explaining a winding manner of wires when the coil component is viewed in the third negative direction; and

FIG. 8 is a diagram explaining the winding manner of wires when the coil component is viewed in the second positive direction.

### DETAILED DESCRIPTION

Hereinafter, first and second embodiments of a coil component will be described. Some drawings illustrate enlarged views of constituent elements for easy understanding. The dimensional proportions of some constituent elements are different from actual dimensional proportions or dimensional proportions in another drawing.

### Coil Component of First Embodiment

### Overall Configuration

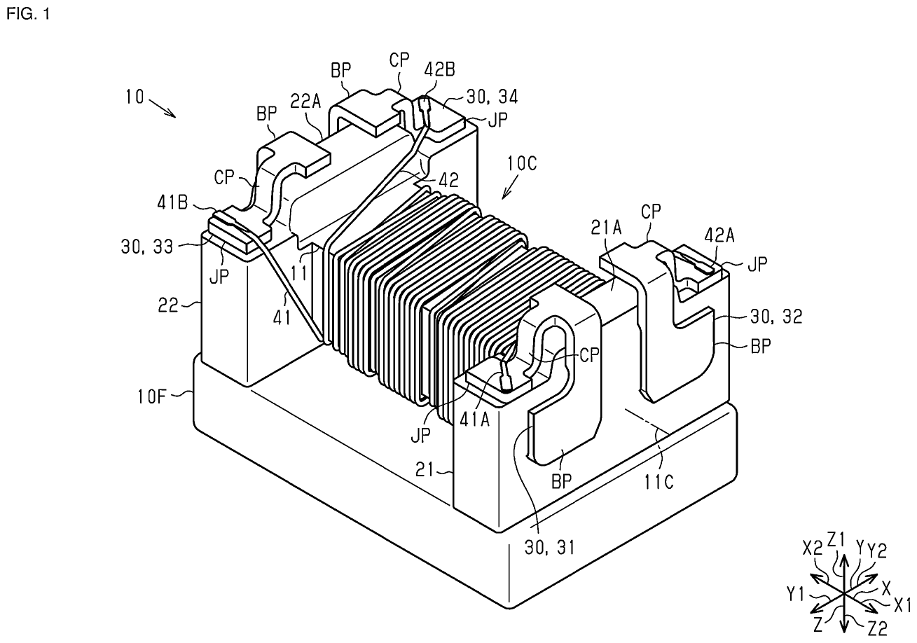

As illustrated in FIG. 1, a coil component 10 includes a drum core 10C and a top plate 10F.

The drum core 10C includes a core portion 11, a first flange portion 21, and a second flange portion 22. The core portion 11 has a rectangular prism shape. The cross-section of the core portion 11 perpendicular to a central axis 11C has a rectangular shape. The “rectangular shape” herein needs to have four sides and generally form a rectangle, including a rectangle with chamfered corners. The core portion 11 is made of Ni—Zn ferrite in the first embodiment. Examples of the material of the core portion 11 can include alumina, Ni—Zn ferrite, synthetic resin, and mixtures thereof.

Herein, a particular axis parallel to the central axis 11C of the core portion 11 is referred to as a first axis X. An axis perpendicular to the first axis X is referred to as a second axis Y In the first embodiment, the second axis Y is parallel to two of the four sides of the core portion 11 when viewed along the first axis X. An axis perpendicular to both the first axis X and the second axis Y is referred to as a third axis Z. In the first embodiment, the third axis Z is parallel to the other two of the four sides of the core portion 11 when viewed along the first axis X. One of the directions along the first axis X is referred to as a first positive direction X1, and the direction opposite to the first positive direction X1 is referred to as a first negative direction X2. In a similar manner, one of the directions along the second axis Y is referred to as a second positive direction Y1, and the direction opposite to the second positive direction Y1 is referred to as a second negative direction Y2. One of the directions along the third axis Z is referred to as a third positive direction Z1, and the direction opposite to the third positive direction Z1 is referred to as a third negative direction Z2. In the first embodiment, a particular direction perpendicular to the central axis 11C corresponds to the third positive direction Z1.

As illustrated in FIG. 1, the first flange portion 21 is coupled to a first end of the core portion 11 on its first positive direction X1 side. The first flange portion 21 with the core portion 11 constitutes a single-piece object. The first flange portion 21 is therefore made of the same Ni—Zn ferrite as the core portion 11.

The first flange portion 21 protrudes outside from the core portion 11 along the second axis Y and along the third axis Z. In the first flange portion 21, a portion 21A at the center along the second axis Y protrudes in the third positive direction Z1 relative to both ends along the second axis Y In other words, the end portion of the first flange portion 21 on its second positive direction Y1 side and the end portion of the first flange portion 21 on its second negative direction Y2 side are recessed in the third negative direction Z2 relative to the portion 21A at the center along the second axis Y.

The second flange portion 22 is coupled to a second end of the core portion 11 on its first negative direction X2 side. The second flange portion 22 with the core portion 11 constitutes a single-piece object. The second flange portion 22 is made of the same Ni—Zn ferrite as the core portion 11.

The second flange portion 22 protrudes from the core portion 11 along the second axis Y and along the third axis Z. In the second flange portion 22, a portion 22A at the center along the second axis Y protrudes in the third positive direction Z1 with respect to both ends along the second axis Y In other words, the end portion of the second flange portion 22 on its second positive direction Y1 side and the end portion of the second flange portion 22 on its second negative direction Y2 side are recessed in the third negative direction Z2 relative to the portion 22A at the center along the second axis Y.

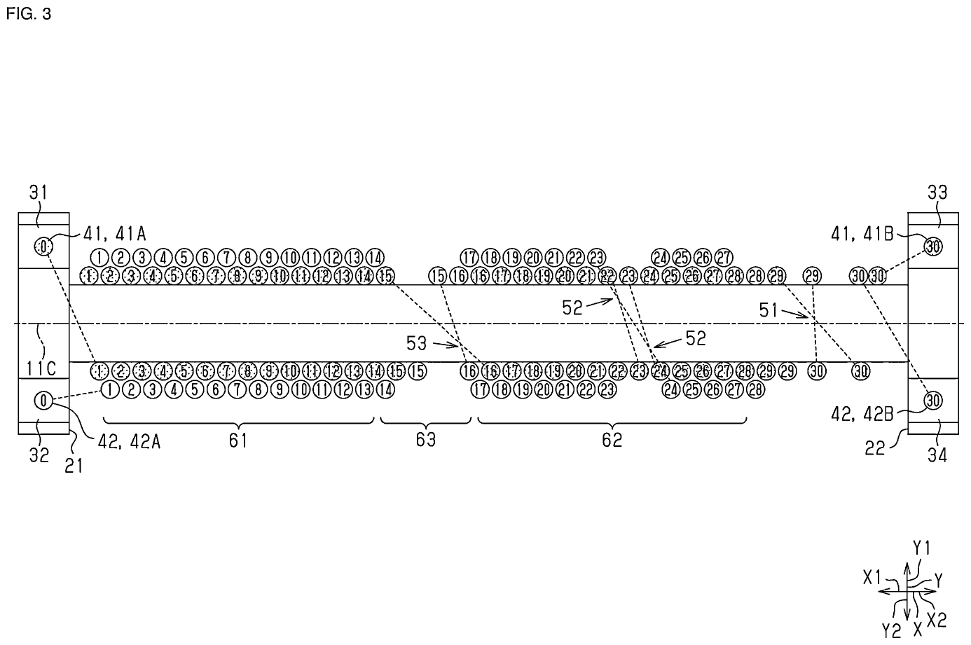

The top plate 10F has a rectangular plate-like shape. The dimension of the top plate 10F along the third axis Z is small compared to its dimension along the first axis X and its dimension along the second axis Y The long sides of the top plate 10F are parallel to the first axis X. The short sides of the top plate 10F are parallel to the second axis Y The top plate 10F is positioned on the third negative direction Z2 side relative to the drum core 10C. The top plate 10F is coupled to both the surface of the first flange portion 21 facing the third negative direction Z2 and the surface of the second flange portion 22 facing the third negative direction Z2. The top plate 10F is thus laid across the first flange portion 21 and the second flange portion 22. The top plate 10F is made of the same Ni—Zn ferrite as the drum core 10C. In FIGS. 3 to 5, illustration of the top plate 10F is omitted.

The coil component 10 includes four outer electrodes 30. The four outer electrodes 30 are a first outer electrode 31, a second outer electrode 32, a third outer electrode 33, and a fourth outer electrode 34. The first outer electrode 31 is attached to the first flange portion 21. On the surface of the first flange portion 21, the first outer electrode 31 is positioned on the second positive direction Y1 side relative to the center of the first flange portion 21 along the second axis Y. Most of the first outer electrode 31 is positioned on the third positive direction Z1 side relative to the core portion 11.

The first outer electrode 31 includes a bonding portion BP, a connecting portion CP, and a joining portion JP. The bonding portion BP, connecting portion CP, and joining portion JP constitute a single-piece object. That is, there are no clear boundaries between these members in the first outer electrode 31.

The bonding portion BP has a substantially plate-like shape. The bonding portion BP has a substantially L shape when viewed BP along the second axis Y This means that the bonding portion BP includes a face perpendicular to the first axis X and a face perpendicular to the third axis Z. A part of the face of the bonding portion BP perpendicular to the first axis X is bonded to the surface of the first flange portion 21 facing the first positive direction X1.

The connecting portion CP has a substantially plate-like shape. The connecting portion CP is coupled to the end face of the bonding portion BP on the second positive direction Y1 side. The connecting portion CP extends in the third negative direction Z2 while extending in the second positive direction Y1. The bonding portion BP has a substantially L shape when viewed along the first axis X. That is, the connecting portion CP has a face perpendicular to the second axis Y and a face perpendicular to the third axis Z.

The joining portion JP has a substantially plate-like shape. The joining portion JP is coupled to the end face of the connecting portion CP on the second positive direction Y1 side. The joining portion JP is positioned on the surface of the first flange portion 21 facing the third positive direction Z1. That is, the joining portion JP is positioned on the surface of the first flange portion 21 on the third positive direction Z1 side relative to the central axis 11C. To the surface of the joining portion JP facing the third positive direction Z1, an end of a later-described wire is coupled. When the joining portion JP to which the wire end is coupled is positioned on the surface of the first flange portion 21 on the third positive direction Z1 side relative to the central axis 11C in such a manner, the first outer electrode 31 is considered to be positioned on the surface of the first flange portion 21 on the third positive direction Z1 side relative to the central axis 11C.

The second outer electrode 32 is attached to the first flange portion 21. On the surface of the first flange portion 21, the second outer electrode 32 is positioned on the second negative direction Y2 side relative to the center of the first flange portion 21 along the second axis Y Most of the second outer electrode 32 is positioned on the third positive direction Z1 side relative to the core portion 11. The shape of the second outer electrode 32 is symmetric to that of the first outer electrode 31. Specifically, the second and first outer electrodes 32 and 31 are symmetric with respect to a virtual plane that passes through the central axis 11C and is perpendicular to the second axis Y The second outer electrode 32 is therefore positioned on the surface of the first flange portion 21 on the third positive direction Z1 side relative to the central axis 11C.

The third outer electrode 33 is attached to the second flange portion 22. On the surface of the second flange portion 22, the third outer electrode 33 is positioned on the second positive direction Y1 side relative to the center of the second flange portion 22 along the second axis Y Most of the third outer electrode 33 is positioned on the third positive direction Z1 side relative to the core portion 11. The shape of the third outer electrode 33 is symmetric to that of the first outer electrode 31. Specifically, the third and first outer electrodes 33 and 31 are symmetric with respect to a virtual plane that is perpendicular to the central axis 11C and passes through the geometric center of the core portion 11. The third outer electrode 33 is therefore positioned on the surface of the second flange portion 22 on the third positive direction Z1 side relative to the central axis 11C.

The fourth outer electrode 34 is attached to the second flange portion 22. On the surface of the second flange portion 22, the fourth outer electrode 34 is positioned on the second negative direction Y2 side relative to the center of the second flange portion 22 along the second axis Y Most of the fourth outer electrode 34 is positioned on the third positive direction Z1 side relative to the core portion 11. The shape of the fourth outer electrode 34 is symmetric to that of the third outer electrode 33. Specifically, the fourth and third outer electrodes 34 and 33 are symmetric with respect to a virtual plane that passes through the central axis 11C and is perpendicular to the second axis Y The fourth outer electrode 34 is therefore positioned on the surface of the second flange portion 22 on the third positive direction Z1 side relative to the central axis 11C.

In the first embodiment, the maximum dimension of the coil component 10 along the first axis X is 3.2 mm. The maximum dimension of the coil component 10 along the second axis Y is 2.5 mm. The maximum dimension of the coil component 10 along the third axis Z is 2.3 mm.

### First Wire and Second Wire

As illustrated in FIG. 1, the coil component 10 includes a first wire 41 and a second wire 42. The first wire 41 and the second wire 42 are wound around the core portion 11. The first wire 41 includes a conductor and an insulation coating, which are not illustrated. The insulation coating covers the outer surface of the conductor. The first wire 41 has a substantially circular shape in a cross section perpendicular to the direction in which the first wire 41 extends.

The second wire 42 has the same configuration as the first wire 41. Specifically, the second wire 42 includes a conductor and an insulation coating. The first wire 41 is indicated with dots in FIGS. 3 to 5.

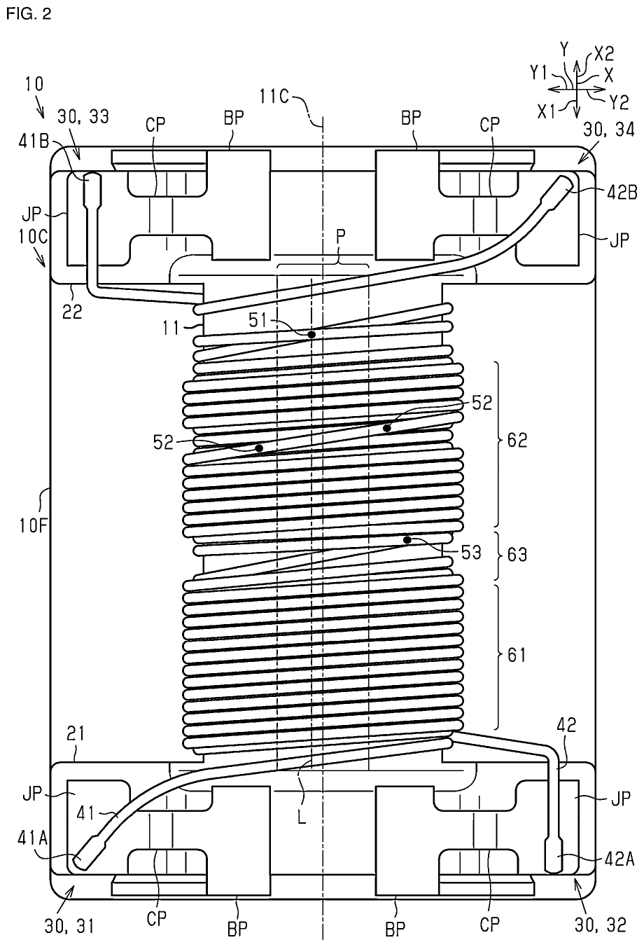

As illustrated in FIG. 2, a first wire end 41A of the first wire 41 is coupled to the first outer electrode 31. A second wire end 41B of the first wire 41 is coupled to the third outer electrode 33. The first wire end 41A and the second wire end 41B are each coupled to the joining portion JP of the corresponding outer electrode 30 by thermocompression bonding. Thermocompression bonding is a process of sandwiching a wire between the outer electrode 30 and a heated jig to melt the wire for fixing the wire to the outer electrode 30.

Herein, when the first wire 41 is traced from the first wire end 41A to the second wire end 41B, the first point that comes into contact with the outer surface of the core portion 11 is defined as a point of 1.0 turn of the first wire 41. In the first embodiment, the point of 1.0 turn of the first wire 41 is positioned on the edge of the core portion 11 on its second negative direction Y2 side and on its third positive direction Z1 side.

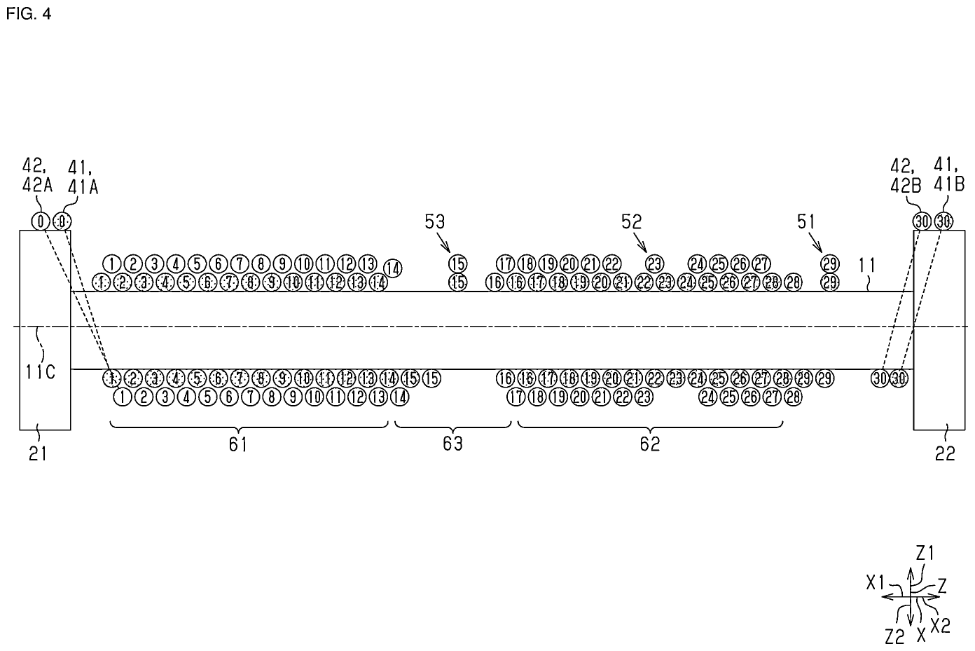

As illustrated in FIGS. 3 and 4, the number of turns of the first wire 41 increases from the first wire end 41A to the second wire end 41B by one each time the first wire 41 turns once around the central axis 11C. When viewed in the first negative direction X2, the first wire 41 is wound clockwise around the core portion 11 with an increase in the number of turns. For example, when viewed in the first negative direction X2, the point of the first wire 41 traced 36 degrees around the central axis 11C from the point of 1.0 turn is referred to as the point of 1.1 turns of the first wire 41. FIG. 3 schematically illustrates the number of turns of each wire on the edges of the core portion 11 on its third positive direction Z1 side. FIG. 4 schematically illustrates the number of turns of each wire positioned on the central axis 11C of the core portion 11 when viewed in the second positive direction Y1.

As illustrated in FIG. 3, the first wire 41 is directly wound around the core portion 11 without the second wire 42 being interposed therebetween in all the turns. The phrase “a wire is directly wound around” herein includes, as well as a condition where the wire is in contact with the outer surface of the core portion 11, a condition where the wire is spaced from the core portion 11 and is wound around the core portion 11 without any wire being interposed therebetween.

The first turn of the first wire 41 corresponds to a section from the point of 1.0 turn of the first wire 41 to just before the point of 2.0 turns. The same applies to the second wire 42. In FIGS. 3 and 4, the part of each wire positioned on its first end side relative to the point of 1.0 turn is illustrated as the 0th turn.

As illustrated in FIG. 2, the first wire end 42A of the second wire 42 is coupled to the second outer electrode 32. The second wire end 42B of the second wire 42 is coupled to the fourth outer electrode 34. The first and second wire ends 42A and 42B are each coupled to the joining portion JP of the corresponding outer electrode 30 by thermocompression bonding.

Herein, when the second wire 42 is traced from the first wire end 42A to the second wire end 42B, the first point whose angular position about the central axis 11C coincides with the angular position of the point of 1.0 turn of the first wire 41 is defined as a point of 1.0 turn of the second wire 42. That is, in the first embodiment, the point of 1.0 turn of the second wire 42 is positioned on a line connecting the central axis 11C and the edge of the core portion 11 on its second negative direction Y2 side and on its third positive direction Z1 side when viewed along the first axis X. In the first embodiment, when the second wire 42 is traced from the first wire end 42A to the second wire end 42B, the point of 1.0 turn of the second wire 42 is in contact with a part of the outer surface of the first wire 41 opposite to the part facing the central axis 11C. The point of 1.0 turn of the second wire 42 may be in contact with the outer surface of the core portion 11.

As illustrated in FIGS. 3 and 4, the number of turns of the second wire 42 increases from the first wire end 42A to the second wire end 42B by one each time the second wire 42 turns once around the central axis 11C. When viewed in the first negative direction X2, the second wire 42 is wound clockwise around the core portion 11 with an increase in the number of turns. That is, the second wire 42 is wound around in the same direction as the first wire 41. Apart of the second wire 42 is wound around the core portion 11 on the outside of the first wire 41. In other words, a part of the second wire 42 is in contact with a part of the outer surface of the first wire 41 opposite to the part facing the central axis 11C.

### Intersection of First Wire and Second Wire

In the following description, N and M are integers greater than or equal to 2. The N-th turn refers to the turn of the first wire 41 including the last point that makes contact with the outer surface of the core portion 11 when the first wire 41 is traced from the first wire end 41A to the second wire end 41B. The M-th turn refers to the turn of the second wire 42 including the last point that makes contact with the outer surface of the core portion 11 when the second wire 42 is traced from the first wire end 42A to the second wire end 42B.

The M-th turn of the second wire 42 and the N-th turn of the first wire 41 do not have an intersection portion at which the M-th turn of the second wire 42 and the N-th turn of the first wire 41 intersect. On the other hand, the (M−1)-th turn of the second wire 42 and the (N−1)-th turn of the first wire 41 have a first intersection portion 51, at which the (M−1)-th turn of the second wire 42 and the (N−1)-th turn of the first wire 41 intersect. The phrase “wires intersect” herein refers to that when one of the wires is traced from its first end to its second end, the wire in the same layer as the other wire once runs on the outer side of the other wire and then returns to the same layer as the other wire. Specifically, the (M−1)-th turn of the second wire 42 includes the first intersection portion 51, at which the (M−1)-th turn of the second wire 42 intersects the (N−1)-th turn of the first wire 41. When the second wire 42 is traced from the first wire end 42A to the second wire end 42B, in the first intersection portion 51, the second wire 42 runs across the first wire 41 from the first negative direction X2 side to the first positive direction X1 side along the central axis 11C. In the first embodiment, as illustrated in FIG. 2, the term “intersection portion” refers to a portion at which the centerline of the second wire 42 intersects the centerline of the first wire 41 when viewed in a direction perpendicular to the central axis 11C of the core portion 11. The above explanation “the centerline of the second wire 42 intersects the centerline of the first wire 41” has the same meaning as “the centerline of the first wire 41 intersects the centerline of the second wire 42”.

In the first embodiment, N is 30 as illustrated in FIGS. 3 and 4. M is 30. That is, the 30th turn of the second wire 42 does not intersect the 30th turn of the first wire 41. The 29th turn of the second wire 42 intersects the 29th turn of the first wire 41. The point of 29.0 turns of the second wire 42 is in contact with the outer surface of the core portion 11 without the first wire 41 being interposed therebetween. In the first intersection portion 51, therefore, the second wire 42 runs on the first wire 41 and crosses over the first wire 41 in the middle of a turn of the second wire 42 directly wound around the outer surface of the core portion 11.

The second wire 42 includes a first outside winding portion 61, a second outside winding portion 62, and an inside winding portion 63. The first outside winding portion 61 is a portion including plural turns wound around the outer periphery of the first wire 41. The first outside winding portion 61 is positioned on the second wire 42's first wire end 42A side relative to the first intersection portion 51. Specifically, the first outside winding portion 61 corresponds to a section from the first turn to the 13th turn of the second wire 42.

The second outside winding portion 62 is positioned on the second wire 42's second wire end 42B side relative to the first outside winding portion 61 and on the second wire 42's first wire end 42A side relative to the first intersection portion 51. The second outside winding portion 62 is a portion including plural turns wound around the outer periphery of the first wire 41. Specifically, the second outside winding portion 62 corresponds to a section from the 17th turn to the 27th turn of the second wire 42.

The second outside winding portion 62 includes first traverse portions 52 on the first wire end 42A side relative to the first intersection portion 51. The first traverse portions 52 traverse the first wire 41. The phrase “a wire traverses the other wire” refers to when one of the wires runs across the other wire without running in the same layer as the other wire. That is, the second outside winding portion 62 includes the first traverse portions 52, which run across the first wire 41 without running in the same layer as the first wire 41. Since the first traverse portions 52 are provided in such a manner, the second outside winding portion 62 includes points of contact with the X-th turn, the (X+1)-th turn, and the (X+2)-th turn of the first wire 41 within one turn (X is a positive integer). As illustrated in FIG. 3, in the first embodiment, in the point of 23.0 turns of the second wire 42, the second wire 42 is positioned between the 21st and 22nd turns of the first wire 41. On the other hand, in the point of 24.0 turns of the second wire 42, the second wire 42 is positioned between the 24th and 25th turns of the first wire 41. That is, the 23rd turn of the second wire 42 in the upper layer has points of contact with the 22nd, 23rd, and 24th turns of the first wire 41. Herein, the groove formed between adjacent two turns of a wire is referred to as a valley. The 23rd turn of the second wire 42 lies across two valleys of the first wire 41 along the central axis 11C.

When the second wire 42 is traced from the first wire end 42A to the second wire end 42B, the second wire 42 runs across the first wire 41 at the first traverse portions 52 from the first positive direction X1 side to the first negative direction X2 side. That is, the direction in which the second wire 42 runs across the first wire 41 along the central axis 11C in the first intersection portion 51 is opposite to the direction in which the second wire 42 runs across the first wire 41 along the central axis 11C in the first traverse portions 52. The situation where a wire in the upper layer runs across a wire in a layer below is expressed as “a wire in the upper layer runs across the wire in the lower layer”. For example, the expression “the second wire 42 runs across the first wire 41” refers to when the second wire 42 in the upper layer intersects the first wire 41 wound in a layer below.

The inside winding portion 63 is positioned between the first outside winding portion 61 and the second outside winding portion 62 along the central axis 11C. The inside winding portion 63 is a winding portion of the second wire 42 at least a part of which is continuously wound around the outer surface of the core portion 11 and which includes less than 1.0 turn continuously wound around the outer periphery of the first wire 41. Specifically, the inside winding portion 63 corresponds to a section from the 14th turn to the 16th turn of the second wire 42.

The inside winding portion 63 includes a second intersection portion 53 which intersects the first wire 41. The second wire 42 includes the second intersection portion 53 which intersects the first wire 41, on the first wire end 42A side relative to the first intersection portion 51. In the second intersection portion 53, the 15th turn of the second wire 42 intersects the 15th turn of the first wire 41. When the second wire 42 is traced from the first wire end 42A to the second wire end 42B, the second wire 42 runs across the first wire 41 in the second intersection portion 53 from the first negative direction X2 side to the first positive direction X1 side. That is, when the second wire 42 is traced from the first wire end 42A to the second wire end 42B, the direction in which the second wire 42 runs across the first wire 41 along the central axis 11C in the first intersection portion 51 is the same as the direction in which the second wire 42 runs across the first wire 41 along the central axis 11C in the second intersection portion 53.

In such a manner, the second wire 42 runs across the first wire 41 in the four portions, including the first intersection portion 51, the two first traverse portions 52, and the second intersection portion 53. In two of those four portions, when the second wire 42 is traced from the first wire end 42A to the second wire end 42B, the second wire 42 runs across the first wire 41 from the first positive direction X1 side to the first negative direction X2 side. In the other two portions, the second wire 42 runs across the first wire 41 in the opposite direction thereto.

### Position of Intersection Portion and Traverse Portion

As illustrated in FIG. 1, the first intersection portion 51, the first traverse portions 52, and the second intersection portion 53 are positioned on the third positive direction Z1 side relative to the central axis 11C. Specifically, the first intersection portion 51, the first traverse portions 52, and the second intersection portion 53 are positioned on the third positive direction Z1 side relative to the central axis 11C on the outer surface of the core portion 11. In such a manner, the first intersection portion 51, the first traverse portions 52, and the second intersection portion 53 are positioned on the same side as the joining portions JP of the outer electrodes 30 with respect to the central axis 11C.

As illustrated in FIG. 2, as the first intersection portion 51 is viewed from the third positive side Z1 side, the core portion 11 is divided into three equal regions in a direction perpendicular to the central axis 11C. That is, the face of the core portion 11 facing the third positive direction Z1 is divided into three equal regions along the second axis Y of the core portion 11. The first intersection portion 51 is positioned in a central region P.

Herein, a virtual line L passing through the first intersection portion 51 in parallel to the central axis 11C is drawn. The second intersection portion 53 is not positioned on the virtual line L. That is, the position of the second intersection portion 53 on the second axis Y is different from that of the first intersection portion 51. Specifically, when viewed in the third negative direction Z2, the second intersection portion 53 is positioned on the second negative direction Y2 side relative to the first intersection portion 51.

### Mode Conversion Characteristic

Ssd12 was measured for the coil component 10 of the first embodiment and a coil component of a comparative example as an indicator of mode conversion characteristics. The dimensions of the coil component of the comparative example were the same as those of the coil component 10 of the first embodiment. The materials of the drum core and the top plate of the coil component of the comparative example were the same as those of the coil component 10 of the first embodiment. The numbers of turns of first and second wires of the coil component of the comparative example were 30, which were the same as those of the coil component 10 of the first embodiment. The winding manner of the coil component of the comparative example is the same as that of the coil component 10 of the first embodiment, other than the first intersection portion. In the coil component of the comparative example, the intersection portion closest to the second ends of the wires was positioned on the outer surface of the core portion 11 on its second negative direction Y2 side and not on the same side as the joining portions JP of the outer electrodes 30 with respect to the central axis 11C. Specifically, the intersection portion in the coil component of the comparative example was in the 30th turns of the first and second wires. 20 pieces were created for each of the coil component 10 and the coil component of the comparative example. That is, the number of prototypes of each coil component was 20.

In the measurement, the coil component 10 of the first embodiment and the coil component of the comparative example were each mounted on an Open Alliance-compliant 3 port substrate. After SOLT calibration, Ssd12 of each coil component was measured. The measurement result acquired from each coil component, that is, the average value of the 20 measurement results was used as a representative value of the measurement result.

Ssd12 of the coil component 10 of the first embodiment was −82.0 dB when the measurement frequency was 500 kHz. Ssd12 of the coil component of the comparative example was −79.6 dB when the measurement frequency was 500 kHz. This revealed that the Ssd12 value could be reduced when the first intersection portion 51 was positioned on the third positive direction Z1 side, that is, on the same side as the joining portions JP of the outer electrodes 30. The effect of reducing the Ssd12 value in the coil component 10 of the first embodiment compared to the comparative example was especially pronounced when the frequency was not higher than 1 GHz.

### Effect of First Embodiment

1-1. According to the first embodiment, the first wire 41 and the second wire 42 do not include an intersection portion in and after the last turn. In other words, the first wire 41 and the second wire 42 do not intersect in the vicinity of the second flange portion 22 as a region where the first wire 41 and the second wire 42 separate from the core portion 11 and are drawn to the respective outer electrodes 30. On the other hand, the first intersection portion 51 is positioned in the turn immediately preceding the last turn of the second wire 42. This means that the first intersection portion 51 is substantially distant from the second wire end 42B along the second wire 42. Heat from the outer electrode 30 is therefore less likely to be transmitted to the first intersection portion 51. This can reduce melting of the coatings of the first and second wires 41 and 42 and the like due to heat in the first intersection portion 51.

1-2. In the first embodiment, the inside winding portion 63 includes the second intersection portion 53, which intersects the first wire 41. Furthermore, the second wire 42 includes the first traverse portions 52, which traverse the first wire 41, on the first wire end 42A side relative to the first intersection portion 51. This configuration can balance the stray capacitance between part around the second intersection portion 53 and part around the first traverse portions 52, thus improving the electric characteristics.

1-3. In the first embodiment, the direction along the central axis 11C in which the second wire 42 runs across the first wire 41 in the first intersection portion 51 is opposite to the direction along the central axis 11C in which the second wire 42 runs across the first wire 41 in the first traverse portions 52. In portions where the second wire 42 runs across the first wire 41, the first wire 41 is wound around while being pressed by the second wire 42. The first wire 41 is therefore subjected to external force in the direction in which the second wire 42 runs across the first wire 41. Since the direction in which the second wire 42 runs across the first wire 41 in the first intersection portion 51 is different from that in the first traverse portions 52, external forces acting on the first wire 41 in the first intersection portion 51 and in the first traverse portions 52 cancel out each other. The aforementioned configuration can prevent the first wire 41 from moving and thereby stabilize the winding of the second wire 42.

1-4. The direction along the central axis 11C in which the second wire 42 runs across the first wire 41 in the first intersection portion 51 is the same as the direction along the central axis 11C in which the second wire 42 runs across the first wire 41 in the second intersection portion 53. That is, the first intersection portion 51, the first traverse portions 52, and the second intersection portion 53 alternate the direction in which the second wire 42 runs across the first wire 41. With this configuration, in the process of winding the second wire 42, the direction of external forces acting on the first wire 41 due to the second wire 42 is not biased. This prevents the first wire 41 from moving and thereby stabilizes the winding of the second wire 42.

1-5. In the first embodiment, the second intersection portion 53 is not positioned on the virtual line L, which passes through the first intersection portion 51 in parallel to the central axis 11C. That is, when viewed in the third negative direction Z2, the first intersection portion 51 and the second intersection portion 53 are different in terms of the position on the second axis Y This configuration stabilizes the winding of the second wire 42 compared to the configuration in which the intersection portions are concentrated at a particular position on the second axis Y.

1-6. In the first embodiment, the first intersection portion 51 is positioned on the third positive direction Z1 side relative to the central axis 11C. In other words, the first intersection portion 51 is positioned on the same side as the joining portions JP of the outer electrodes 30. This configuration reduces the asymmetry in electric characteristics, including inductance and capacitance, thus improving the mode conversion characteristics as revealed by the measurement results of Ssd12. That is, according to this configuration, Ssd12 is improved compared to the coil component in which the first intersection portion 51 is included in the 30th turns and positioned on the second negative direction Y2 side.

1-7. In the first embodiment, the first intersection portion 51 is positioned in the central region P of the three regions obtained by equally dividing the core portion 11 in the second positive direction Y1 as the first intersection portion 51 is viewed from the third positive direction Z1 side. The first intersection portion 51 being positioned in the central region P prevents disorderly winding in the first intersection portion 51. Especially in the vicinity of the last turn, it is difficult to obtain the effect of turns limiting movement of the turns adjacent thereto. The aforementioned configuration can therefore efficiently reduce disorderly winding in the first intersection portion 51.

### Coil Component of Second Embodiment

Hereinafter, a coil component 100 of a second embodiment will be described. The same configurations as those of the first embodiment are given the same reference numerals, and the description thereof will be omitted or simplified.

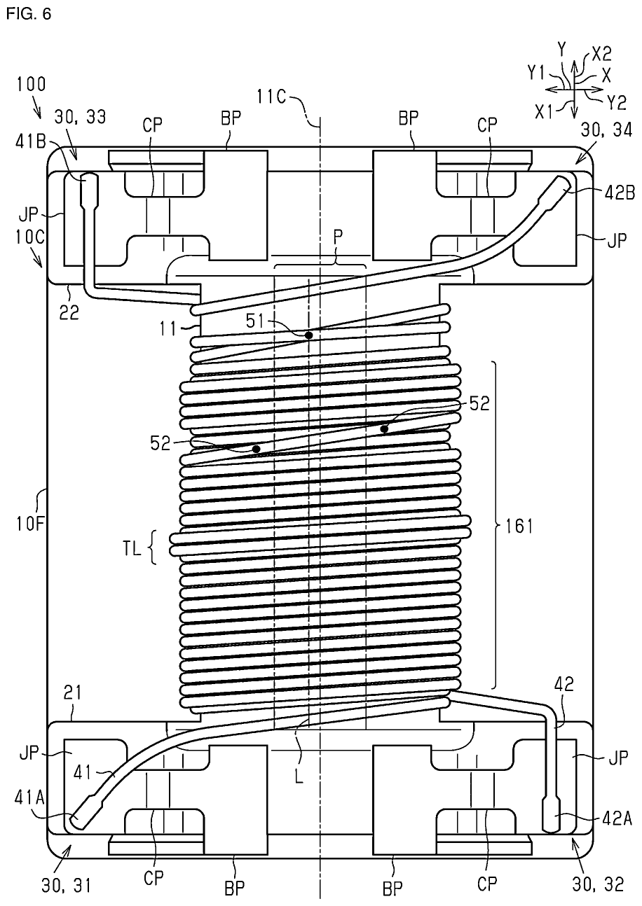

As illustrated in FIG. 6, in the coil component 100 of the second embodiment, the second wire 42 is different from that of the first embodiment in not including the inside winding portion 63. Furthermore, the second wire 42 in the coil component 100 of the second embodiment is different from that of the first embodiment in including a multilayer portion TL described later.

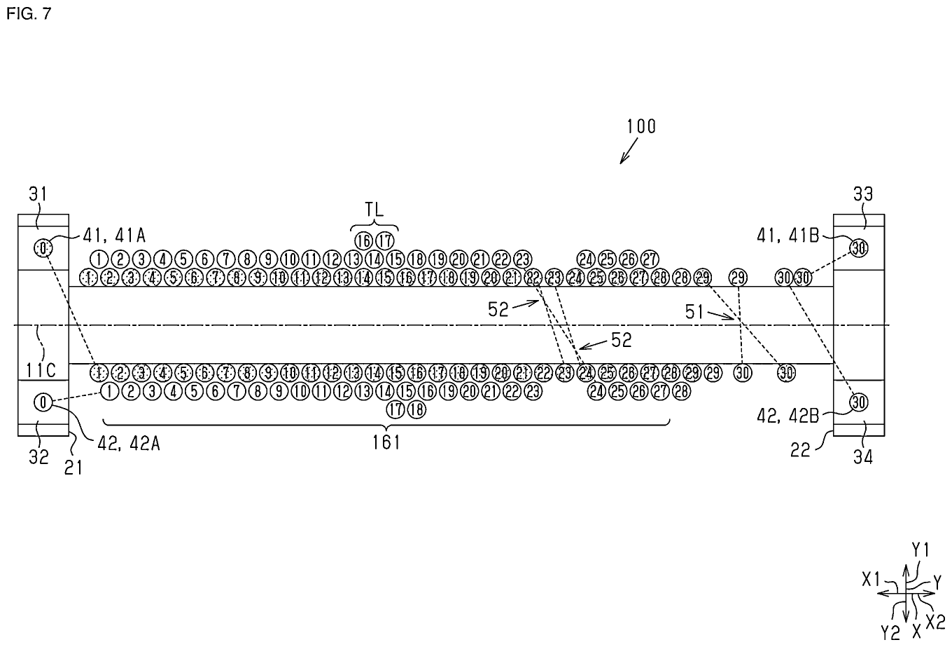

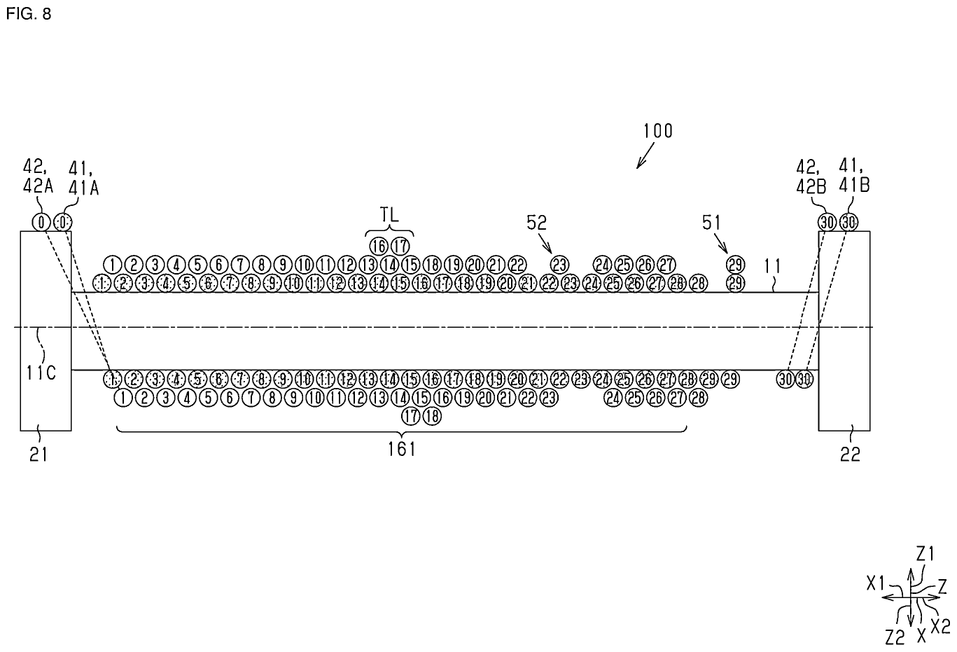

As illustrated in FIGS. 7 and 8, the second embodiment is the same as the first embodiment in that the second wire 42 includes the first intersection portion 51. That is, the M-th turn of the second wire 42 and the N-th turn of the first wire 41 do not include an intersection portion at which the M-th turn of the second wire 42 and the N-th turn of the first wire 41 intersect. Furthermore, the (M−1)-th turn of the second wire 42 and the (N−1)-th turn of the first wire 41 include the first intersection portion 51, at which the (M−1)-th turn of the second wire 42 and the (N−1)-th turn of the first wire 41 intersect. N and M are also 30 in the second embodiment.

### Second Wire

In the coil component 100 of the second embodiment, the second wire 42 includes an outside winding portion 161. The outside winding portion 161 is a portion including plural turns wound around the outer periphery of the first wire 41. The outside winding portion 161 is positioned on the second wire 42's first wire end 42A side relative to the first intersection portion 51. Specifically, the outside winding portion 161 corresponds to a section of the second wire 42 from the first turn to the 27th turn.

The outside winding portion 161 includes the first traverse portions 52, which traverse the first wire 41, on the first wire end 42A side relative to the first intersection portion 51. Since the first traverse portions 52 are provided, the outside winding portion 161 of the second wire 42 includes points of contact with the X-th turn, the (X+1)-th turn, and the (X+2)-th turn of the first wire 41 within one turn (X is a positive integer).

Specifically, as illustrated in FIG. 7, the point of 23.0 turns of the second wire 42 is positioned between the 21st turn and the 22nd turn of the first wire 41. On the other hand, the point of 24.0 turns of the second wire 42 is positioned between the 24th turn and the 25th turn of the first wire 41. That is, the 23rd turn of the second wire 42 in the upper layer includes points of contact with the 22nd turn, 23rd turn, and 24th turn of the first wire 41.

As illustrated in FIGS. 7 and 8, the outside winding portion 161 of the second wire 42 includes the multilayer portion TL. The multilayer portion TL is a portion of the outside winding portion 161 that extends across one or more continuous turns and includes two or more layers of the second wire 42 wound around. The multilayer portion TL is positioned on the first wire end 42A side relative to the first traverse portions 52. In other words, the first traverse portions 52 are positioned on the first wire end 42A side relative to the first intersection portion 51 and on the second wire end 42B side relative to the multilayer portion TL. In the second embodiment, the multilayer portion TL is a portion of the second wire 42 from the middle of the 16th turn to the middle of the 18th turn. The multilayer portion TL extends across about two continuous turns and includes two or more layers of the second wire 42 wound around.

Specifically, in the outside winding portion 161, the second wire 42 is directly wound around the outer periphery of the first wire 41, from the point of 1.0 turn to the point of about 16.5 turns. The second wire 42 is directly wound around the outer periphery of the first wire 41, from the point of about 18.5 turns to the point of about 28.0 turns. The second wire 42, from the point of about 16.5 turns to the point of about 18.5 turns, is directly wound around the 16th and preceding turns of the second wire 42. In other words, the second wire 42, from the point of about 16.5 turns to the point of about 18.5 turns, runs on the outer side of the first layer of the second wire 42. The phrase “the second wire 42 is directly wound around” includes, as well as a condition where the second wire 42 is in contact with the outer surface of the first wire 41 or the second wire 42, a condition where the second wire 42 is spaced from the wire below.

To be more specific, in the multilayer portion TL, the point of about 16.5 turns of the second wire 42 is positioned between the point of about 13.5 turns and the point of about 14.5 turns of the second wire 42. The point of about 17.5 turns of the second wire 42 is positioned between the point of about 14.5 turns and the point of about 15.5 turns of the second wire 42. That is, at the point of about 16.5 turns, the 16th turn of the second wire 42 runs on the outer side of the 13th and 14th turns of the second wire 42. The 17th turn of the second wire 42 runs on the outer side of the 14th and 15th turns of the second wire 42. In the multilayer portion TL, the second wire 42 is laid on itself in two layers. In the multilayer portion TL, therefore, the first and second wires 41 and 42 are laid in three layers in total. In the multilayer portion TL, the second wire 42 includes a part where the second wire 42 intersect itself. In the part where the second wire 42 intersect itself, three turns of the second wire 42 are arranged in the direction perpendicular to the central axis 11C.

In such a manner, the 16th turn of the second wire 42 in the multilayer portion TL is like being wound back toward the first flange portion 21 by about two turns. In turns before the multilayer portion TL, the X-th turn of the second wire 42 is positioned in the valley between the X-th turn and the (X−1)-th turn of the first wire 41. On the other hand, in turns after the multilayer portion TL and before the first traverse portions 52, the X-th turn of the second wire 42 is positioned in the valley between the (X−2)-th turn and the (X−1)-th turn of the first wire 41. In the multilayer portion TL, therefore, the second wire 42 traverses the first wire 41 from the first negative direction X2 side to the first positive direction X2 side when the second wire 42 is traced from the first wire end 41A to the second wire end 42B. Furthermore, while the second wire 42 is wound forward from the two-layer part to the one-layer part after the multilayer portion TL, the second wire 42 traverses the first wire 41 from the first positive direction X1 side to the first negative direction X2 side.

### Effect of Second Embodiment

According to the second embodiment, the following effects are exerted in addition to the aforementioned effects 1-1, 1-3, 1-5, 1-6, and 1-7 of the first embodiment.

2-1. In the second embodiment, the outside winding portion 161 of the second wire 42 includes the multilayer portion TL, in which the second wire 42 is wound around the outer periphery of the first wire 41 in two or more layers. The provision of the multilayer portion TL allows switching whether the position of the X-th turn of the second wire 42 is on the first positive direction X1 side or on the first negative direction X2 side relative to the X-th turn of the first wire 41. By switching the positional relationship between wires along the central axis 11C in such a manner, it is possible to adjust stray capacitance generated between the wires.

2-2. In the second embodiment, the outside winding portion 161 includes the first traverse portions 52 on the first wire end 42A side relative to the first intersection portion 51 and on the second wire end 42B side relative to the multilayer portion TL. In such a manner, the first traverse portions 52 are not arranged extremely close to the first flange portion 21 or the second flange portion 22. This can reduce the asymmetry in electric characteristics, including inductance and capacitance, thus improving the mode conversion characteristics.

### Modification

The aforementioned embodiments and the following modifications can be carried out in combination within a technically consistent range.

### Modification for Coil Component

The top plate 10F of the coil component 10 may be omitted in the aforementioned embodiments. The dimensions of the coil components 10 are not limited to the examples of the aforementioned embodiments.

The shape of the core portion 11 is not limited to the examples of the aforementioned embodiments. For example, the core portion 11 may have a cylindrical shape or a polygonal prism shape other than the rectangular prism shape.

The configuration of the drum core 10C is not limited to the examples of the aforementioned embodiments. For example, the first flange portion 21 and the second flange portion 22 do not need to protrude in the third positive direction Z1 at the center along the second axis Y For example, the first and second flange portions 21 and 22 may have a fork-like shape recessed at the center along the second axis Y.

The method of coupling the joining portions JP of the outer electrodes 30 to ends of wires is not limited to thermocompression bonding. For example, ends of wires may be joined to the joining portions JP with a laser or may be joined thereto by another method.

The material and shape of the outer electrodes 30 are not limited to the examples of the aforementioned embodiments although the outer electrodes 30 need to be able to be coupled to the first and second wires 41 and 42. For example, each outer electrode 30 may include a metal layer and a plating layer, and the wires may be coupled to the plating layer.

### Modification for Wire

The values of N and M are not limited as long as they are integers greater than or equal to 2 in the aforementioned embodiments. For example, the values of N and M may be different.

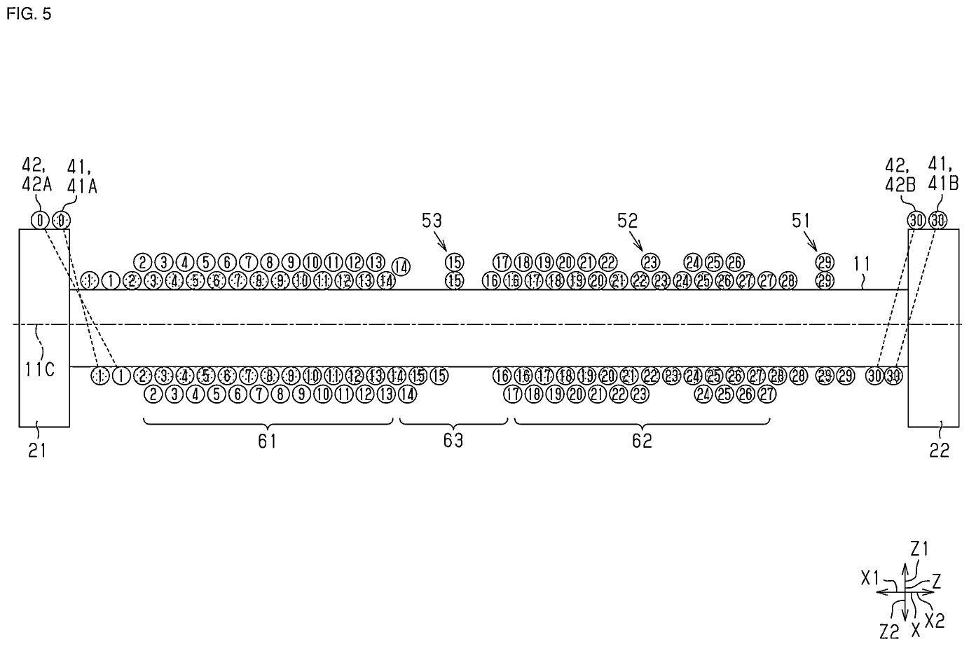

The number of turns of the first outside winding portion 61, the number of turns of the second outside winding portion 62, and the number of turns of the inside winding portion 63 are not limited to the examples of the aforementioned embodiments. For example, in the example illustrated in FIG. 5, the second wire 42, at the position of 1.0 turn, is directly wound around the outer surface of the core portion 11 without the first wire 41 being interposed therebetween. Specifically, the first turn of the second wire 42 is positioned on the first negative direction X2 side relative to the first turn of the first wire 41. The second wire 42 is wound around the outer periphery of the first wire 41 from the second turn to the 13th turn. That is, the first outside winding portion 61 corresponds to a section from the second turn to the 13th turn.

In the example illustrated in FIG. 5, the second wire 42 is wound around the outer periphery of the first wire 41 from the 17th turn to the 26th turn. In the middle of the 27th turn, the second wire 42 is directly wound around the outer surface of the core portion 11 without the first wire 41 being interposed therebetween. That is, the second outside winding portion 62 corresponds to a section from the 17th turn to the 26th turn.

In the example illustrated in FIG. 5, the inside winding portion 63 is positioned between the first outside winding portion 61 and the second outside winding portion 62 along the central axis 11C. The inside winding portion 63 is a portion which includes less than 1.0 turn of the second wire 42 continuously wound around the outer periphery of the first wire 41. Specifically, the inside winding portion 63 corresponds to a section from the 14th turn to the 16th turn of the second wire 42.

In the example illustrated in FIG. 5, the second turn of the second wire 42, as well as the first turn of the first wire 41, exists on the outer surface of the core portion 11 in or before the second turn of the first wire 41. The first turns of the two wires are able to limit movement of the second and subsequent turns of the first wire 41 in the first positive direction X1. This can reduce disorderly winding of the second and subsequent turns of the first and second wires 41 and 42.

The second wire 42 may include, in addition to the first outside winding portion 61 and the second outside winding portion 62, an outside winding portion including plural turns wound around the outer periphery of the first wire 41. The second wire 42 may include, in addition to the inside winding portion 63, an inside winding portion which includes less than 1.0 turn of the second wire 42 continuously wound around the outer periphery of the first wire 41 in each turn. For example, in the aforementioned embodiments, the second wire 42 may include a third outside winding portion, a second inside winding portion, and the second outside winding portion 62 in this order on the second wire end 42B side relative to the inside winding portion 63.

The first traverse portions 52 and the second intersection portion 53 may be omitted from the second wire 42. Specifically, all the first traverse portions 52 and the second intersection portion 53 may be omitted, or either the first traverse portions 52 or the second intersection portion 53 may be omitted. For example, either the first traverse portions 52 or the second intersection portion 53 may be properly employed depending on the number of times a wire runs across the other wire in the region each wire is drawn out from the core portion 11 and reaches the corresponding outer electrode 30, the direction in which the wire runs across the other wire, and the like.

The direction along the central axis 11C in which the second wire 42 runs across the first wire 41 in the first intersection portion 51 may be the same as the direction along the central axis 11C in which the second wire 42 runs across the first wire 41 in the first traverse portions 52. The direction in which the second wire 42 runs across the first wire 41 can be properly changed depending on whether the second wire 42 runs across the first wire 41 in another portion, the direction in which the second wire 42 runs across the first wire 41 in another portion, and the like.

The direction along the central axis 11C in which the second wire 42 runs across the first wire 41 in the first intersection portion 51 may be opposite to the direction along the central axis 11C in which the second wire 42 runs across the first wire 41 in the second intersection portion 53. The direction in which the second wire 42 runs across the first wire 41 can be properly changed depending on whether the second wire 42 runs across the first wire 41 in another portion, the direction in which the second wire 42 runs across the first wire 41 in another portion, and the like.

The second wire 42 does not need to intersect the first wire 41 in the vicinity of the 1.0 turn of the second wire 42 when the coil component 10 is viewed in the second positive direction Y1. When the second wire 42 includes plural pairs of intersection portions where the second wire 42 runs across the first wire 41 in different directions, the wires can be prevented from twisting each other as a whole.

The first intersection portion 51 may be positioned in a place other than the central region P. The positions of the first intersection portion 51 along the central axis 11C, along the second axis Y, and along the third axis Z are not limited to the examples of the aforementioned embodiments. That is, the first intersection portion 51 may be positioned on the outer surface of the core portion 11 other than the face facing the third positive direction Z1. As a result, the first intersection portion 51 may be positioned on the outer surface of the core portion 11, in a direction different from the direction in which the outer electrodes 30 are positioned in each flange portion.

In the first intersection portion 51, the first wire 41 may run across the outer side of the second wire 42. That is, the (M−1)-th turn of the second wire 42 and the (N−1)-th turn of the first wire 41 need to intersect in the first intersection portion 51, but either one can be positioned outside in the first intersection portion 51.

### Modification for Multilayer Portion

In the second embodiment, the number of turns before the multilayer portion TL begins and the number of turns before the multilayer portion TL ends are not limited to the examples of the aforementioned embodiments. The multilayer portion TL needs to extend across one or more continuous turns and include two or more layers of the second wire 42 wound around. The multilayer portion TL may extend across one turn or may extend across three or more turns.

The position of the multilayer portion TL is not limited to the example of the second embodiment. That is, the multilayer portion TL may be positioned on the second wire end 42B side relative to the first traverse portion 52. In other words, the first traverse portions 52 may be positioned on the first wire end 42A side relative to the multilayer portion TL.

### Note

The technical ideas derived from the aforementioned embodiments and modifications will be described below.

[1]A coil component including: a drum core including: a columnar core portion; a first flange portion coupled to a first end of the core portion in a direction along a central axis; and a second flange portion coupled to a second end of the core portion on a side opposite to the first end; a first outer electrode and a second outer electrode that are positioned on a surface of the first flange portion; a third outer electrode and a fourth outer electrode that are positioned on a surface of the second flange portion; a first wire that is wound around the core portion and has a first wire end coupled to the first outer electrode and a second wire end coupled to the third outer electrode; and a second wire that is wound around the core portion in the same direction as the first wire and has a first wire end coupled to the second outer electrode and a second wire end coupled to the fourth outer electrode. An M-th turn of the second wire and an N-th turn of the first wire do not have an intersection portion at which the M-th turn of the second wire and the N-th turn of the first wire intersect, and an (M−1)-th turn of the second wire and an (N−1)-th turn of the first wire have a first intersection portion at which the (M−1)-th turn of the second wire and the (N−1)-th turn of the first wire intersect where N and M are integers greater than or equal to 2. When the first wire is traced from the first wire end to the second wire end, a first point that makes contact with an outer surface of the core portion is defined as a point of 1.0 turn of the first wire. The number of turns increases from the first wire end toward the second wire end of the first wire by one each time the first wire turns once around the central axis; and the N-th turn refers to a turn that includes a last point that makes contact with the outer surface of the core portion when the first wire is traced from the first wire end to the second wire end. When the second wire is traced from the first wire end to the second wire end, a first point whose angular position about the central axis coincides with an angular position of the point of 1.0 turn of the first wire is defined as a point of 1.0 turn of the second wire; the number of turns increases from the first wire end toward the second wire end of the second wire by one each time the second wire turns once around the central axis; and the M-th turn refers to a turn including a last point that makes contact with the outer surface of the core portion when the second wire is traced from the first wire end to the second wire end.

[2] The coil component according to [1], in which the second wire includes an outside winding portion including a plurality of turns wound around an outer periphery of the first wire, the outside winding portion includes a first traverse portion on the second wire's first wire end side relative to the first intersection portion, and the first traverse portion runs across the first wire without running in the same layer as the first wire.

[3] The coil component according to [2], in which when the second wire is traced from the first wire end to the second wire end, the direction along the central axis in which the second wire runs across the first wire in the first intersection portion is opposite to the direction along the central axis in which the second wire runs across the first wire in the first traverse portion.

[4] The coil component according to any one of [1] to [3], in which the second wire includes: a first outside winding portion including a plurality of turns wound around an outer periphery of the first wire; a second outside winding portion which is positioned on a second wire end side relative to the first outside winding portion and includes a plurality of turns wound around the outer periphery of the first wire; and an inside winding portion which is positioned between the first outside winding portion and the second outside winding portion in the direction along the central axis. At least a part of which is wound around the outer surface of the core portion, and which includes less than 1.0 turn of the second wire continuously wound around the outer periphery of the first wire, and the inside winding portion includes a second intersection portion that intersects the first wire.

[5] The coil component according to [4], in which when the second wire is traced from the first wire end to the second wire end, the direction along the central axis in which the second wire runs across the first wire in the first intersection portion is the same as the direction along the central axis in which the second wire runs across the first wire in the second intersection portion.

[6] The coil component according to [5], in which the second intersection portion is not positioned on a virtual line that passes through the first intersection portion in parallel to the central axis.

[7] The coil component according to any one of [1] to [6], in which when a particular direction perpendicular to the central axis is defined as a positive direction, the first outer electrode and the second outer electrode are positioned on a positive direction side relative to the central axis on a surface of the first flange portion, the third outer electrode and the fourth outer electrode are positioned on the positive direction side relative to the central axis on a surface of the second flange portion, and the first intersection portion is positioned on the positive direction side relative to the central axis on an outer surface of the core portion.

[8] The coil component according to [7], in which when the first intersection portion is viewed from the positive direction side and the core portion is divided into three equal regions in a direction perpendicular to both the central axis and the particular direction, the first intersection portion is positioned in a region at a center.

[9] The coil component according to any one of [1] to [8], in which the second wire includes an outside winding portion that includes a plurality of turns wound around an outer periphery of the first wire, and the outside winding portion includes a multilayer portion which extends across one or more continuous turns and includes two or more layers of the second wire wound around.

[10] The coil component according to [9], in which the outside winding portion includes a first traverse portion on the second wire's first wire end side relative to the first intersection portion and the second wire's second wire end side relative to the multilayer portion, and the first traverse portion runs across the first wire without running in the same layer as the first wire.

What is claimed is:

1. A coil component comprising:
a drum core including:
a columnar core portion;
a first flange portion coupled to a first end of the core portion in a direction along a central axis; and
a second flange portion coupled to a second end of the core portion on a side opposite to the first end;
a first outer electrode and a second outer electrode that are on a surface of the first flange portion;
a third outer electrode and a fourth outer electrode that are on a surface of the second flange portion;
a first wire that is wound around the core portion and has a first wire end connected to the first outer electrode and a second wire end connected to the third outer electrode; and
a second wire that is wound around the core portion in the same direction as the first wire and has a first wire end connected to the second outer electrode and a second wire end connected to the fourth outer electrode,
wherein
N and M are integers equal to or greater than 2,
an M-th turn of the second wire and an N-th turn of the first wire do not have an intersection portion at which the M-th turn of the second wire and the N-th turn of the first wire intersect, and
an (M−1)-th turn of the second wire and an (N−1)-th turn of the first wire have a first intersection portion at which the (M−1)-th turn of the second wire and the (N−1)-th turn of the first wire intersect,
when the first wire is traced from the first wire end to the second wire end, a first point in which the first wire makes a first contact with an outer surface of the core portion is defined as a point of 1.0 turn of the first wire;
a number of turns increases by one turn each time the first wire turns once around the central axis from the first wire end toward the second wire end of the first wire;
and the N-th turn of the first wire refers to a turn including a last point in which the first wire makes a last contact with the outer surface of the core portion when the first wire is traced from the first wire end to the second wire end,
when the second wire is traced from the first wire end to the second wire end, a first point whose angular position of the second wire about the central axis coincides with an angular position of the point of 1.0 turn of the first wire is defined as a point of 1.0 turn of the second wire;
a number of turns increases by one turn each time the second wire turns once around the central axis from the first wire end toward the second wire end of the second wire; and
the M-th turn of the second wire refers to a turn including a last point in which the second wire makes a last contact with the outer surface of the core portion when the second wire is traced from the first wire end to the second wire end.

2. The coil component according to claim 1, wherein
the second wire includes an outside winding portion including a plurality of turns of the second wire wound around an outer periphery of the first wire, and
the outside winding portion includes a first traverse portion in which the second wire straddles the first wire without arriving at the same layer as the first wire at the first wire end side of the second wire with respect to the first intersection portion.

3. The coil component according to claim 2, wherein
when the second wire is traced from the first wire end to the second wire end, the direction along the central axis in which the second wire straddles the first wire in the first intersection portion is opposite to the direction along the central axis in which the second wire straddles the first wire in the first traverse portion.

4. The coil component according to claim 1, wherein
the second wire includes:
a first outside winding portion including a plurality of turns of the second wire wound around an outer periphery of the first wire;
a second outside winding portion which is on a second wire end side with respect to the first outside winding portion and includes a plurality of turns of the second wire wound around the outer periphery of the first wire; and
an inside winding portion which is between the first outside winding portion and the second outside winding portion in the direction along the central axis, at least a portion of the second wire being wound around the outer surface of the core portion, and at least a portion of the second wire including less than 1.0 turn of the second wire continuously wound around the outer periphery of the first wire, and
the inside winding portion includes a second intersection portion at which the second wire intersects the first wire.

5. The coil component according to claim 4, wherein
when the second wire is traced from the first wire end to the second wire end, the direction along the central axis in which the second wire straddles the first wire in the first intersection portion is the same as the direction along the central axis in which the second wire straddles the first wire in the second intersection portion.

6. The coil component according to claim 5, wherein
the second intersection portion is not on a virtual line which is parallel to the central axis and passes through the first intersection portion.

7. The coil component according to claim 1, wherein
when a specific direction orthogonal to the central axis is defined as a positive direction,
the first outer electrode and the second outer electrode are on a surface of the first flange portion in the positive direction side with respect to the central axis,
the third outer electrode and the fourth outer electrode are on a surface of the second flange portion in the positive direction side with respect to the central axis, and
the first intersection portion is on an outer surface of the core portion on the positive direction side with respect to the central axis.

8. The coil component according to claim 7, wherein
when the first intersection portion is viewed from the positive direction side and the core portion is divided into three equal regions in a direction orthogonal to both the central axis and the specific direction, the first intersection portion is in a region at a center.

9. The coil component according to claim 1, wherein
the second wire includes an outside winding portion that includes a plurality of turns of the second wire wound around an outer periphery of the first wire, and
the outside winding portion includes a multilayer portion in which the second wire is wound around continuously in at least one turn and in two or more layers.

10. The coil component according to claim 9, wherein
the outside winding portion includes a first traverse portion in which the second wire straddles the first wire without arriving at the same layer as the first wire on first wire end side of the second wire with respect to the first intersection portion and the second wire end side of the second wire with respect to the multilayer portion.
